(19) United States
(12) Patent Application Publication
(10) Pub. No.: US 2012/0126615 A1
(43) Pub. Date: May 24, 2012

(54) Production Line Capable of Supplying Electric Power

(75) Inventors: Run-Hua Hang, Chung-Ho (TW); Yan-Yu Sun, Chung-Ho (TW); Ching-Feng Hsieh, Wanhua District (TW)

(73) Assignee: Askey Computer Corporation, Chung-Ho (TW)

(21) Appl. No.: 12/961,075

(22) Filed: Dec. 6, 2010

(30) Foreign Application Priority Data
Nov. 23, 2010 (TW) 99140302

(51) Int. Cl. H02G 11/00

(52) U.S. Cl. 307/12

(57) ABSTRACT

A production line includes a carrier board having a power socket that has a plurality of power lines and a plurality of conductive elements connected to the power lines, respectively; a track having a track body and a pair of track sidewalls; a plurality of electricity-collecting tracks provided on the track body for supplying different power signals; and a plurality of guarding units, each of which has a supporting frame perpendicularly provided on the track body and a covering sheet connected to the supporting frame for covering the electricity-collecting tracks, a plurality of crevices formed between each of the covering sheets; wherein each of the conductive elements has a contact end penetrating and extending into each of the crevices and flexibly contacting each of the corresponding electricity-collecting tracks so as to receive the different power signals and transmit the different power signals to the power lines of the power socket.

### BACKGROUND OF THE INVENTION

1. Field of the Invention

The present invention relates to production lines, and more particularly, to a production line capable of supplying electric power for rendering a moving carrier board to supply power in the whole moving procedure.

2. Description of Related Art

During manufacturing or test of an electronic equipment, the electronic equipment often needs electric power so as to perform operation such that certain function is detected for that whether it meets requirements of the industry or not. Therefore, a power socket is provided on a carrier board for carrying the electronic equipment on a production line such that a detector provides power to the power socket for the usage of the electronic equipment through power lines.

The production line provides a track used to carry and move the carrier board. Additionally, the track provides an electricity-collecting track that has a plurality of conducting wheels with different electrode properties (positive power, negative power and ground). The carrier board has a plurality of rollers provided on a surface thereof such that the carrier board readily moves on the production line by rotation of the rollers of the carrier board when the carrier board is disposed on the track. The carrier board further has a plurality of metal strips electrically connected to the conducting wheels provided on a surface thereof with the rollers whereas the carrier board has a power socket electrically connecting the conductive metal strip provided on a surface thereof backward the roller and the plurality of conductive metal strips such that the electronic equipment disposed on the carrier board obtain power supply directly from the power socket.

In a detection procedure, a plurality of the carrier boards are arranged on the production line. During proceeding of the carrier board, a crevice may unavoidably exist between two carrier boards such that the electricity-collecting track arranged on the production line is exposed between the carrier boards. Accordingly, once a conductive object falls on the electricity-collecting track between the two carrier boards, the conducting wheels with different electrode properties are likely short-circuited and thus, the production line is damaged. Moreover, when the detector pushes the carrier board, the detector may also readily touch the electricity-collecting track exposed on a bottom surface of the carrier board. In addition, a situation of the detector touching the electricity-collecting track often generates when the electronic equipment is detected with a problem and needs to be moved out of the track of the production line. Hence, it extremely exists a hidden danger problem of security.

### SUMMARY OF THE INVENTION

In view of the above-mentioned problems of the prior art, it is an objective of the present invention to provide a production line capable of supplying electric power effectively solving a hidden danger problem of power supply security existing on a production line track with respect to a procedure of an operator pushing a carrier board on the product line.

For achieving the previously described objective and other relevant objectives, the present invention provides a production line capable of supplying electric power for transporting an electronic equipment in need of the electric power, comprising: a track having a track body and a pair of track sidewalls perpendicularly provided on the track body along an extending direction of the track body; a plurality of electricity-collecting tracks provided on the track body along the extending direction of the track body and positioned between the track sidewalls, wherein each of the electricity-collecting tracks is used to supply different power signals; a plurality of guarding units provided on the track body along the extending direction of the track body and positioned between the track sidewalls, wherein each of the guarding units has a supporting frame perpendicularly provided on the track body and a covering sheet connected to the supporting frame and used to correspondingly cover each of the electricity-collecting tracks, and wherein a plurality of crevices corresponding to each of the electricity-collecting tracks and extending along the extending direction of the track body are formed between each of the covering sheets; and a carrier board for carrying the electronic equipment, supported on the guarding units by the track sidewalls and capable of moving along the extending direction of the track body through the track sidewalls, wherein the carrier board has a power socket having a plurality of power lines provided on a upper surface thereof and a plurality of conductive elements correspondingly connected to the plurality of power lines respectively provided on a lower surface thereof, wherein the amount of the power lines are corresponding to the amount of the conductive elements and the electricity-collecting tracks, and wherein each of the conductive elements has a contact end penetrating each of the crevices and flexibly contacting each of the corresponding electricity-collecting tracks so as to receive the different power signals from each of the electricity-collecting tracks and transmit the different power signals to each of the power lines of the power socket.

In the previously described production line, each of the conductive elements has an I-shaped, Z-shaped, L-shaped or inverted T-shaped cross section, and the cross section of each of the conductive elements is based on a direction of the carrier board moving on the track.

In the previously described production line capable of supplying electric power, two adjacent conducting wheels on each of the electricity-collecting tracks are spaced at a distance less than the length of the contact end of each of the conductive elements along the extending direction of the track body.

In the previously described production line capable of supplying electric power, the covering sheet of each of the guarding units is made from insulation materials.

As previously described, the production line capable of supplying electric power in accordance with the present invention primarily adopts the guiding units for covering the electricity-collecting track to prevent the electricity-collecting track positioned on the previously described track from exposure so as to further avoid occurrence of situations of a short circuit due to a conductive object from outside falling on the electricity-collecting track and the production line operator touching the electricity-collecting track by accident, thereby having higher security. Hence, the present invention effectively overcomes the above-mentioned problems of the prior art.

### BRIEF DESCRIPTION OF DRAWINGS

FIG. 1 illustrates a stereoscopic decomposition diagram of a production line capable of supplying electric power in accordance with the present invention;

FIG. 2 illustrates a section diagram of the production line capable of supplying electric power sectioned in a direction of a carrier board moving in a track in accordance with the present invention;

FIG. 3 illustrates a locally enlarged appearance diagram of a electricity-collecting track of the production line capable of supplying electric power in accordance with the present invention; and

FIG. 4 illustrates a section diagram of a carrier board and a track sidewall of the production line capable of supplying electric power in accordance with another embodiment of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

Furthermore, the drawings of the present invention are all schematically simplified diagrams and only schematically illustrate the basic technique idea of the present invention. Hence, the drawings only illustrate relevant elements in accordance with the present invention while not depending on amount, shape and size of each element in actual implementation. Type, amount and proportion of each element in actual implementation may be changed arbitrarily.

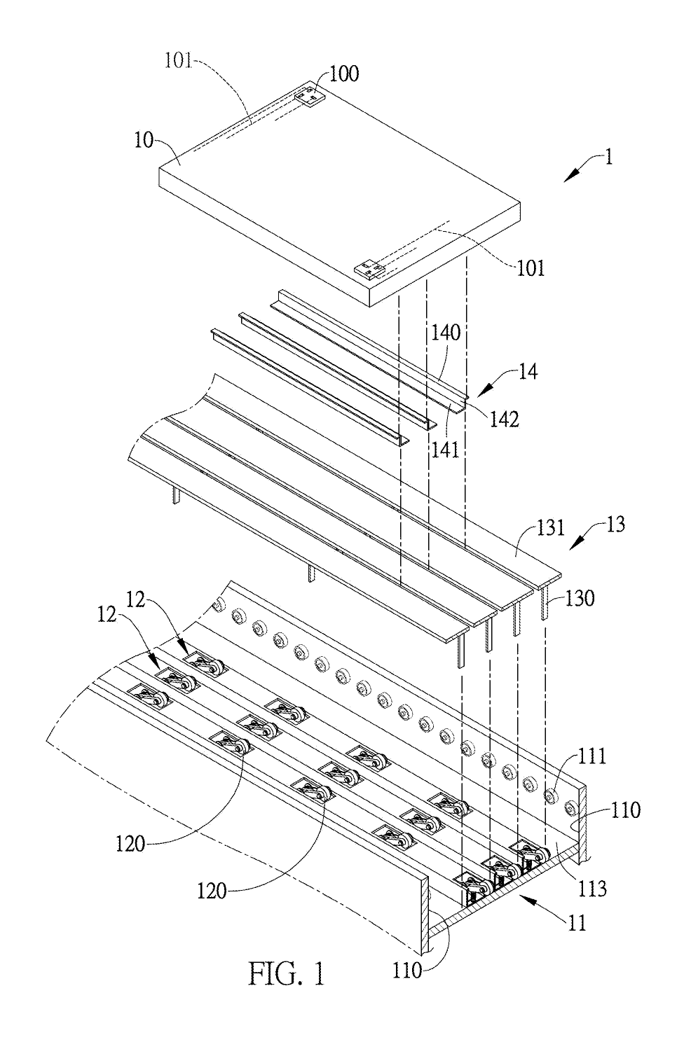

As illustrated in FIG. 1, a stereoscopic decomposition diagram of a production line 1 capable of supplying electric power in accordance with the present invention is shown. The production line 1 is used to supply electric power to an electronic equipment in need of the electric power such that the electronic equipment operates so as to perform function-detecting operation on the production line 1. The production line 1 in accordance with the present invention comprises a carrier board 10, a track 11, a plurality of electricity-collecting tracks 12 and a plurality of guarding units 13.

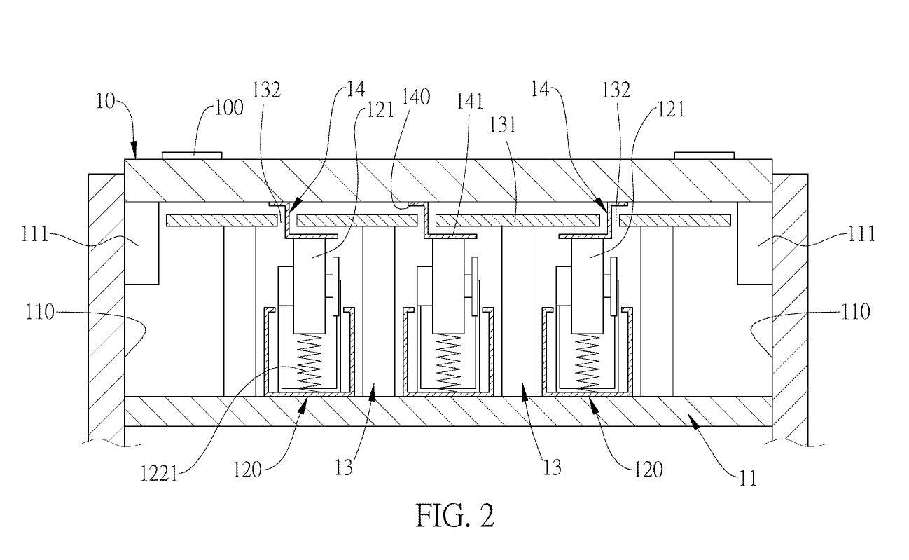

In order to more clearly illustrate the disposition relation of the carrier board 10, the track 11, the electricity-collecting tracks 12 and the guarding units 13 of the production line 1 in accordance with the present invention, please also refer to FIG. 2, which shows a section diagram of the production line 1 sectioned in a direction of the carrier board moving in the track in accordance with the present invention.

The carrier board 10 is used to carry the previously described electronic equipment in need of power supply (not shown). The electronic equipment may be a monitor, a television, a notebook and the like. The carrier board 10 provides a power socket 100 having a plurality of power lines 101 on a carrying surface thereof for carrying the electronic equipment (that is, an upper surface), and provides a plurality of conductive elements 14 respectively corresponding to and connected to the plurality of power lines 101 on a surface toward the electricity-collecting track 12 (that is, a lower surface). The amount of the plurality of power lines 101 are corresponding to the amount of the plurality of conductive elements 14 and the plurality of electricity-collecting tracks 12. Each of the conductive elements 14 comprises a metal strip 140 provided on the lower surface of the carrier board 10 and correspondingly connected to each of the power lines 101 and an electric conduction sheet 142 connected to the metal strip 140. The electric conduction sheet 142 has a contact end 141 by which the power line 101 transmits a power signal to the power socket 100. The metal strip 140 of the conductive element 14 may be fastened to the carrier board 10 by a fastening mode, such as an adhesive or a fastening member being adopted in the form of riveting, screwing and the like. Furthermore, each of the electric conduction sheets 142 is a flexible electric conduction sheet for flexibly contacting each of the corresponding electricity-collecting tracks 12.

The track 11 has a track body 113 and a pair of track sidewalls 110 provided perpendicularly on the track body 113 along an extending direction of the track body 113. The track sidewalls 110 provide a plurality of rollers 111 spacing with each other on opposite surfaces thereof. The rollers 111 are used to support the carrier board 10 such that the carrier board 10 moves along the extending direction of the track body 113. The electricity-collecting tracks 12 are respectively provided on the track body 113 along the extending direction of the track body 113 and positioned between the track sidewalls 110. Each of the electricity-collecting tracks 12 is used to supply different power signals. Each of the electricity-collecting tracks 12 comprises a plurality of conducting wheels 120 previously spacing with each other and a plurality of flexible units 1221 supporting the conducting wheels 120, respectively. Each of the conducting wheels 120 and each of the corresponding flexible units 1221 are used to flexibly contact the contact end 141 of each of the conductive elements 14 so as to transmit different power signals to each of the conductive elements 14.

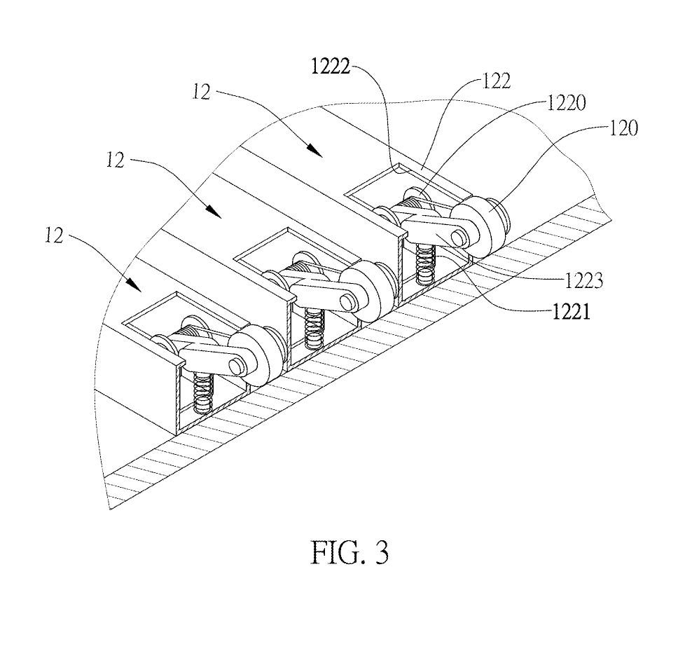

Herein, the details of the previously described electricity-collecting track 12 are illustrated by using FIG. 3 as an example. The electricity-collecting track 12 further comprises an electricity-collecting frame 122 extensively provided on the track body 113 along the extending direction of the track body 113 and used to mount the conducting wheel 120. Each of the electricity-collecting frames 122 provides a wheel base 1220 and an opening 1222 according to each of the conducting wheels 120. The wheel base 1220 has a position limiting arm 1223 jointed with the conducting wheel 120 provided on an end thereof such that the position limiting arm 1223 lifts the conducting wheel 120 so as to render a wheel surface of the conducting wheel 120 to protrude through the opening 1222 of the electricity-collecting frame 122. The wheel base 1220 has the previously described flexible unit 1221 provided on a side thereof, for instance, a supporting spring. The flexible unit 1221 is used to push the position limiting arm 1223. Therefore, the conducting wheel 120 protruding through the opening 1222 of the electricity-collecting frame 122 may be prevented from slumping in the electricity-collecting frame 122 due to the weight of the carrier board 10 by using the flexibility of the flexible unit 1221 to push the position limiting arm 1223 when the carrier board 10 positioned on the track 11 moves.

Furthermore, in terms of the different power signals and the electricity-collecting tracks 12 provided separately in the previous description, the different power signals comprise a positive power signal, a negative power signal and a ground signal. Hence, the present invention provides the guarding unit 13 on a side adjacent to each of the electricity-collecting tracks 12 so as to prevent a production line operator from getting an electric shock due to touching the conducting wheel 120 by accident when the production line operator performs pushing operation of the carrier board 10 disposed on the track 11, or prevent a power short-circuited situation of a production line resulted from a conductive object contacting the conducting wheel 120 due to falling between the tracks 11. The guarding unit 13 is provided on the track body 113 along the extending direction of the track body 113 and positioned between the track sidewalls 110. Each of the guarding units 13 has a supporting frame 130 perpendicularly provided on the track body 113 and a covering sheet 131 connected to the supporting frame 130 and used to correspondingly cover each of the electricity-collecting tracks 12. Each of the covering sheets 131 is made from insulation materials, such as wood materials, plastic materials and the like. The electricity-collecting track 12 having the power signal may be rendered not to be exposed on a surface of the track 11 so as to effectively prevent the occurrence of the previously described situation since the covering sheet 131 covers the electricity-collecting track 12.

In order to cooperate with the previously described guarding unit 13, the power supply of the power socket 100 of the carrier board 10 in accordance with the present invention is accomplished by the conductive element 14 electrically contacting the conducting wheel 120. As the previous description, the covering sheet 131 used to cover the conducting wheel 120 suspends over a bottom surface of the track 11 through the supporting frame 130 and covers an adjacent conducting wheel 120. A vertical crevice is formed between the covering sheeting 131 and the conducting wheel 120 covered by the covering sheeting 131. Additionally, each of the guarding units is provided separately, and thus a horizontal crevice is formed between the guarding units 13. That is, a plurality of crevices 132 corresponding to the electricity-collecting tracks 12 and extending along the extending direction of the track body 113 are formed between the covering sheets 131. Therefore, the conductive element 14 is provided on the carrier board 10 by cooperating with the vertical crevice and horizontal crevice previously described.

The contact end 141 of each of the conductive elements 14 extends into the vertical crevice formed by each of the covering sheets 131 covering the conducting wheel 120 and contacts the conducting wheel 120, thereby the conductive elements 14 transmitting the power signals of the conducting wheels 120 contacted by the conductive elements 14 to the power socket 100 on the carrier board 10 through the power lines 101 connected to the conductive elements 14 such that the power socket 100 obtains power supply. Moreover, a situation of the flexible unit 1221 not contacting the conducting wheel 120 or the flexible unit 1221 unduly repressing the conducting wheel 120 such that the conducting wheel 120 is damaged due to the tolerance of design may be avoided by the conducting wheel 120 flexibly contacting with the conductive element 14 via the flexible unit 1221. In another illustrative embodiment, the conductive element 14 may also be a metal sheet having flexibility so as to from flexible contact with the conducting wheel 120.

It may be understood from FIG. 2 that each of the conducting wheels 120 having the power signal is covered by the covering sheet 131 of the guarding unit 13, and the conductive elements 14 are respectively provided in the vertical crevices formed between each of the covering sheets 131 and the conducting wheel 120 covered by the covering sheet 131 and in the horizontal crevice formed by the guarding units 13 separately disposed, so as to transmit the power signal of each of the conducting wheels 120 to the power socket 100 on the carrier board 10 through the power line 101 connected to the conductive element 14, such that the power socket 100 of the carrier board 10 may obtain the power signal so as to supply power to the electronic equipment on the carrier board 10 to be detected (not shown) for a detecting test. In addition, the production line operator may avoid getting an electric shock, or a power short-circuited situation of the production line resulting from the conductive object contacting the conducting wheel 120 due to falling between the tracks 11 may be prevented during the production line operator performing the pushing operation of the carrier board 10 on the rollers 111 supported on the two track sidewalls 110.

Furthermore, as illustrated in FIG. 2, besides a Z-shaped structure or an I-shaped structure, the conductive element 14 may be in an L-shaped structure or an inverted T-shaped structure.

In addition, the distance between the two adjacent conducting wheels 120 on each of the electricity-collecting tracks 12 is less than the length of the contact end 141 of each of the conductive elements 14 along the extending direction of the track body 113 such that the conductive element 14 continuously transmits the power signal to the power socket 100 of the carrier board 10 in the whole procedure of the carrier board 10 moving on the track 11. Hence, the conductive element 14 of the carrier board 10 may be assured to contact at least one of the conducting wheels 120 having different power signals during moving on the carrier board 10 so as to further render the power socket 100 on the carrier board 10 to continuously supply power.

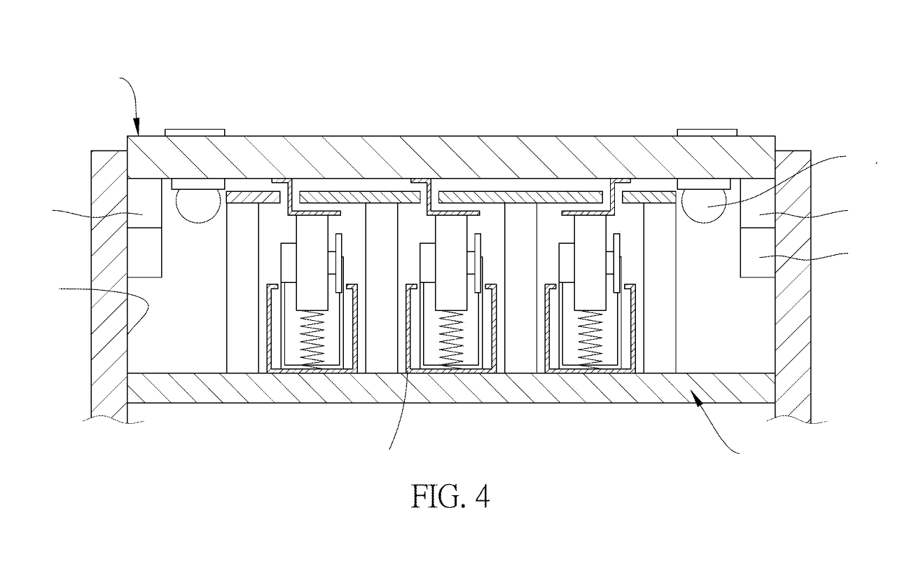

It should be illustrated herein, the production line capable of supplying electric power in accordance with the present invention is not limited in the form of the track 11 shown in FIG. 1. For example, the track sidewalls 110 may not provide the roller 111. As illustrated in FIG. 4, the illustrative embodiment providing guiding strips 112 or guiding grooves on the two track sidewalls 110′, and providing a plurality of first rolling members on a surface of the carrier board 10′ toward the electricity-collecting track 12, for instance, rollers 103 or balls, such that the rollers 103 may slide on the guiding strip 112 may also achieve the same effect of the carrier board 10′ moving along the direction of the track 11′. Furthermore, a plurality of second rolling members provided on a surface of the carrier board 10′ toward the track 11′ (that is, a lower surface), for instance, rollers 102 or balls, are used to roll on another object such that the carrier board 10′ rolls on the another object. In other word, different changes are based on implementation aspects.

In conclusion, the production line capable of supplying electric power in accordance with the present invention primarily adopts the plurality of guiding units for covering the electricity-collecting track to prevent the electricity-collecting track positioned on the previously described track from exposure so as to further avoid occurrence of situations of a short circuit due to a conductive object from outside falling on the electricity-collecting track and the production line operator touching the electricity-collecting track by accident, thereby having higher security.

The foregoing descriptions of the detailed embodiments are only exemplarily illustrated to disclose the features and functions of the present invention and not restrictive of the scope of the present invention. One skilled in the art could modify and vary the previous embodiments without violating the spirit and principle of the present invention. Hence, it should be understood to those in the art that all modifications and variations according to the spirit and principle in the disclosure of the present invention should fall within the scope of the appended claims.

What is claimed is:

1. A production line capable of supplying power, for transporting an electronic equipment in need of the power, comprising:
a track having a track body and a pair of track sidewalls perpendicularly provided on the track body along an extending direction of the track body;
a plurality of electricity-collecting tracks provided on the track body along the extending direction and positioned between the track sidewalls, wherein each of the electricity-collecting tracks supplies different power signals;
a plurality of guarding units provided on the track body along the extending direction of the track body and positioned between the track sidewalls, wherein each of the guarding units has a supporting frame perpendicularly provided on the track body and a covering sheet connected to the supporting frame and used to correspondingly cover each of the electricity-collecting tracks, and wherein a plurality of crevices corresponding to the electricity-collecting tracks and extending along the extending direction of the track body are formed between each of the covering sheets; and
a carrier board for carrying the electronic equipment, supported on the guarding units by the track sidewalls and capable of moving along the extending direction of the track body through the track sidewalls, wherein the carrier board has a power socket having a plurality of power lines provided on an upper surface thereof and a plurality of conductive elements correspondingly connected to the power lines respectively provided on a lower surface thereof, wherein the power lines are corresponding in amount to the conductive elements and the electricity-collecting tracks, and wherein each of the conductive elements has a contact end penetrating each of the crevices and flexibly contacting each of the corresponding electricity-collecting tracks so as to receive the different power signals from each of the electricity-collecting tracks and transmit the different power signals to each of the power lines of the power socket.

2. The production line of claim 1, wherein the track sidewalls have a plurality of separately arranged rollers provided on opposite surfaces thereof, and wherein the rollers are used to support the carrier board such that the carrier board moves along the extending direction of the track.

3. The production line of claim 1, wherein each of the conductive elements has an I-shaped, Z-shaped, L-shaped or inverted T-shape cross section, and the cross section of each of the conductive elements is based on a direction of the carrier board moving on the track.

4. The production line of claim 1, wherein the different power signals comprise a positive power signal, a negative power signal and a grounding power signal.

5. The production line of claim 1, wherein each of the electricity-collecting tracks comprises a plurality of conducting wheels arranged with a predetermined interval and a plurality of flexible units supporting the conducting wheels, respectively, and wherein each of the conducting wheels and each of the corresponding flexible units are used to flexibly contact the contact end of each of the conductive elements.

6. The production line of claim 5, wherein two adjacent ones of the conducting wheels on each of the electricity-collecting tracks are spaced at a distance less than a length of the contact end of each of the conductive elements along the extending direction of the track body.

7. The production line of claim 5, wherein the electricity-collecting track further comprises a plurality of electricity-collecting frames extensively provided on the track body along the extending direction of the track body and used to mount the conducting wheel, each of the electricity-collecting frames providing a wheel base and an opening according to each of the conducting wheels, and the wheel base having a position limiting arm jointed with the conducting wheel provided on an end thereof such that the position limiting arm lifts the conducting wheel so as to render a wheel surface of the conducting wheel to protrude through the opening of the electricity-collecting frame, wherein the flexible unit is used to push the position limiting arm.

8. The production line of claim 1, wherein the carrier board has a plurality of first rolling members provided on a surface thereof toward the track for rolling the carrier board on the track sidewalls such that the carrier board moves along the extending direction of the track body and a plurality of second rolling members provided on the surface thereof toward the track for rolling on another object such that the carrier board moves on the another object.

9. The production line of claim 1, wherein the covering sheet of each of the guarding units is made from insulation materials.

10. The production line of claim 1, wherein each of the conductive elements comprises a metal strip provided on the lower surface thereof and correspondingly connected to each of the power lines and an electric conduction sheet connected to the metal strip, and wherein the electric conduction sheet has the contact end.

11. The production line of claim 10, wherein each of the electric conduction sheets is a flexible electric conduction sheet, and is used to flexibly contact each of the corresponding electricity-collecting tracks.
